(19) United States
(12) Patent Application Publication
(10) Pub. No.: US 2006/0145947 A1
(43) Pub. Date: Jul. 6, 2006

(54) Foldable electronic device with virtual image display

(76) Inventors: Theodore R. Arneson, Ivanhoe, IL (US); David E. Devries, Palatine, IL (US); John C. Neumann, Chicago, IL (US); Michael L. Charlier, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 11/028,414

(22) Filed: Jan. 4, 2005

(51) Int. Cl. G09G 3/00

(52) U.S. Cl. 345/32

(57) ABSTRACT

An electronic device (400) has a second body (405) with an image generation apparatus (450) and an optical system (460) and, a first body (445) for providing a virtual image. The first body (445) is foldably attached to the second body (405). Further, the electronic device (400) can include a third body (465) for providing a standard display (470) that is foldable attached to the second body.

### CROSS REFERENCE TO RELATED APPLICATIONS

This application is related to the following U.S. patent applications:
“Electronic Device with Virtual Image Display” (Attorney Docket No. CS25640RL) by Theodore R. Arneson, John C. Neumann, and Michael L. Charlier; and
“System and Method for Automatic Display Switching” (Attorney Docket No. CS25638RL) by Theodore R. Arneson, Michael L. Charlier, and John C. Neumann.
   All of the related applications are filed on even date herewith, are assigned to the assignee of the present application, and are hereby incorporated herein in their entirety by this reference thereto.

### FIELD OF THE INVENTION

The present invention relates to electronic devices with one or more displays.

### BACKGROUND OF THE INVENTION

Electronic devices such as mobile phones are known to have various design features including a display. There is a growing need for users of electronic devices to receive files, pictures and contents from the Internet or other sources. Since many pictures and files have sufficiently large display screen requirements, it is difficult to recognize and capture all the information with the display provided by the liquid crystal display (LCD) panels of mobile phones.

There is need for an improved electronic device, which can provide images with a larger field-of-view to allow users to view images and files from the Internet or any such source. Additionally, such electronic devices need to be designed to be user-friendly and enable a user to view such images even as the user performs other functions on these electronic devices.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention.

FIG. 1 shows an exemplary configuration of an electronic device with a first body and a second body in accordance with a first embodiment.

FIG. 2 shows an exemplary configuration of the electronic device showing the components in the first body in accordance with a second embodiment.

FIG. 3 shows a third embodiment of the electronic device wherein the electronic device is in a stowed position to illustrate components in the first body.

FIG. 4 shows a fourth embodiment of the electronic device wherein the electronic device is in a stowed position.

FIG. 5 shows the electronic device of FIG. 4 wherein the electronic device is in a predetermined opened position with respect to the first body.

FIG. 6 shows a fifth embodiment of the electronic device in a partially stowed position such that the first body is positioned at the bottom of the second body.

FIG. 7 shows the electronic device of FIG. 6 wherein the first body is in a predetermined opened position.

FIG. 8 shows a user using an electronic device to view a virtual display.

FIG. 9 is a flow diagram depicting the steps for generating the virtual image in the first body of FIGS. 1-8.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and is not to be limited by the embodiments shown below.

It is further understood that the use of relational term, if any, such as first and second, top and bottom, and the like are used solely for distinguishing one from another entity or action without necessarily requiring or implying any actual such relationship or order between such entities or actions. Much of the inventive functionality and many of the inventive principles are best implemented with electronic and optical devices and equipment. It is expected that one of ordinary skill, notwithstanding possibly significant effort and many design choices, when guided by the concepts and principles disclosed herein will be readily capable of generating such electronic devices with minimal experimentation. Therefore, in the interest if brevity and minimization of any risk of obscuring the principles and concepts according to the present invention, further discussion of such electronic device, if any, will be limited to the essentials with respect to the principles and concepts within the preferred embodiments.

The embodiments address the problem of viewing high content images, documents, and web pages on a portable handset within the typically available view area. The invention allows two use modes: far-to-eye (normal phone display viewing) and near-to-eye. Thus, the user can view both low and high content displays. Because full web pages can be viewed, low content Wireless Access Protocol (WAP) based browsing is no longer needed.

Improvements in technology have made it possible to achieve high-speed data transmission rates. Therefore data, such as multimedia, requiring high-speed data transmission rates can be transmitted across a network without noticeable delay. This makes it possible to view high-resolution multimedia data, on an electronic device, including a mobile phone. However, in the case of electronic devices such as mobile phones, the size of the electronic device is a major constraint that limits the display area. Considering the rate at which mobile phones and such other electronic devices are being increasingly used to access the web or any such similar service, there is a need to harmonize two conflicting needs of having a small display size and at the same time providing a higher resolution image viewing facility. High-resolution multimedia could be displayed by providing a display with an increased Field of View (field-of-view). High-resolution multimedia could be better displayed by increasing the field-of-view. Several methods have been proposed to obtain a larger field-of-view, such as utilizing a magnifying telescope inside the substrate, or utilizing prism magnifiers, etc. However, the field-of-view can only be improved to a limited extent with these methods and usually with disadvantages in terms of size and weight.

An electronic device has a first body for providing a virtual image, a second body hingeably attached to the first body, an image generation apparatus in the second body for providing a real image, and an optical system in the second body for assisting in transforming the real image to the virtual image. Thus, the electronic device is capable of providing a virtual image with a large field-of-view through the first body, which rotate with respect to the second body of the electronic device, enabling the user to use the display while performing other functions on the device. Thus, a user can enjoy an electronic device with a virtual image display or a display element providing better quality images, a larger field of view, and ease of use while being able to view the virtual image in various positions, and maintaining a desirable size of the device. Furthermore, the display element can be protected by the electronic communication device when not in use.

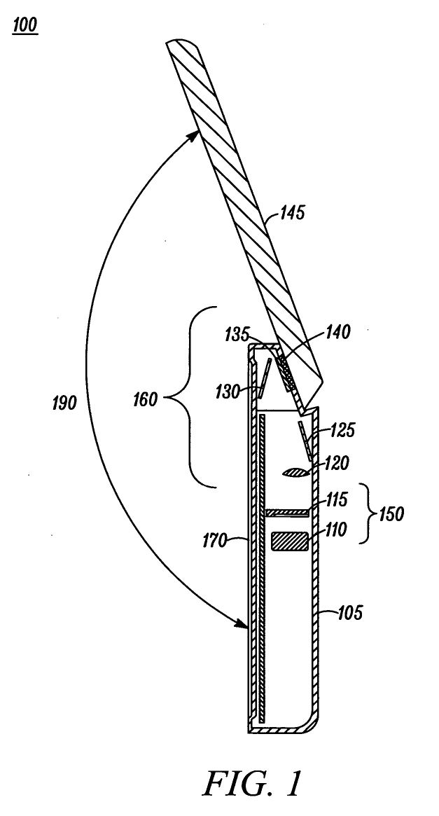

FIG. 1 depicts an exemplary diagram of an electronic device 100 in accordance with a first embodiment having a first body 145 enabled to provide a virtual image and a second body 105 moveably attached to the first body 145. The first body 145 is a cover to the electronic device 100 and includes a substrate guided optical element. The first body 145 is capable of being moved over an angle of zero to about 170 degrees relative to the second body 105. The second body 105 houses the image generation apparatus 150 that is responsible for generating a real image in the second body 105 of the electronic device 100. Further, the second body 105 includes an optical system 160 that is responsible for guiding the light rays emanating from the real image, generated in the second body 105, into the first body 145 to generate a virtual image.

According to an embodiment, the first body is a substrate guided optical element. The substrate guided optical element enables the projection of the virtual image with a larger field-of-view, while still controlling the thickness of the element. According to an embodiment the substrate guided optical element is developed by Lumus. The basic element of this technology, called a light-guide optical element (LOE), is a flat and small transparent body that can be reduced to the size of an eyeglass lens. This technology facilitates very compact, personal, screen-less, high-resolution and high-brightness image displays. When combined with a microdisplay real image source, it projects a high-quality virtual image directly into the eye of the viewer. Although the projecting element is small, a large image is viewed through it. Though the virtual image is viewed at a near-to-eye distance, the substrate guided optical element allows a larger field-of-view, and yet results in a 40% reduction in the device volume, when compared to conventional optics such as optical wave guides. Another advantage of using the Lumus light guided optical element (or a similar element) is a reduction of cost due to lower requirements of optical components.

In an embodiment, the first body 145 should be in a predetermined opened position relative to the second body 105 for the virtual image to be generated properly in the first body 145. The predetermined opened position is attained by moving the first body 145 relative to the second body 105 from a stowed position where the first body 145 covers a front of the second body 105. When not in active use, the electronic device 100 is in the stowed position. The virtual image display of the electronic device 100 is activated when the first body 145 is flipped to the predetermined opened position. As per one embodiment, where the electronic device 100 is a clamshell mobile phone, the predetermined opened position would be the position in which a clamshell phone is normally used e.g., the first body 145 at a predetermined angle θ 190 to the second body 105. In the embodiment shown in FIG. 1, the predetermined opened position is such that the first body 145 is at a nominal angle of 160 degrees relative to the second body 105.

In the predetermined opened position, the optical system 160 in the second body 105 is able to properly guide the light rays of the real image from the second body 105 into the first body 145. The relevance of the predetermined opened position is that if the first body 145 and the second body 105 are misaligned, the light rays of the real image would not be incident at a required angle into the first body 145. Such misaligned incidence of the light rays into the first body 145 causes ghosting of images. Ghosting of images is a phenomenon wherein a faint image, similar in appearance to the virtual image, appears in the first body 145 at a position where it was not intended to appear. The virtual image generated in the first body would not suffer from any ghosting when the first body is in the predetermined opened position relative to the second body.

The image generation apparatus 150 in the second body 105 generates the real image. In this embodiment, the image generation apparatus 150 includes a microdisplay 115 with a backlight 110 that brightens the image. In another embodiment, the microdisplay 115 could include a liquid crystal display (LCD). A switch (not shown) provides an indication of whether the first body 145 is in the predetermined opened position with respect to the second body 105. This switch (not shown) activates the image generation apparatus 150 when the first body 145 is in the predetermined opened position with respect to the second body 105. On the other hand, the switch deactivates the image generation apparatus 150 when the first body 145 is not in the predetermined opened position with respect to the second body 105. Deactivating the image generation apparatus 150 when not in use limits unnecessary use of the image generation apparatus 150, reduces power consumption, and prevents the image generation apparatus 150 and the second body 105 from unnecessary heating.

The real image generated by the image generation apparatus 150 is beamed through a converging lens 120. The converging lens 120 manipulates the real image, by making it either larger or smaller. The real image so generated is incident onto a first reflective surface 125. The first reflective surface may direct the image onto a second reflective surface 130. The first reflective surface 125 and the second reflective surface 130 are aligned with respect to each other to guide the light rays emanating from the real image into the first body 145 to produce a virtual image. The first reflective surface 125 and the second reflective surface 130 could be surfaces of a prism.

The light rays of the real image that are reflected from the first and the second reflective surfaces 125, 130 pass through a first collimator 135 before entering the first body 145. The first collimator 135 is placed in the second body 105. On entering the first body 145, the light rays of the real image are passed through a second collimator 140. The first collimator 135 and the second collimator 140 are optical devices that operate such that any rays of light at an angle to each other (not parallel to each other) are rendered parallel when they pass though the first and second collimators 135, 140. The light rays upon passing through the optical system 160 including the converging lens 120, the first and second reflective surfaces 125, 130 and the first and second collimators 135, 140 result in being at a proper angle of incidence to enter the first body 145 because the light rays are parallel to each other to generate a clear virtual image in the first body 145. As an alternative to two collimators, a single collimator could be used. A single collimator can be placed in one of the two positions used by the two collimators.

The first body 145 has a substrate guided optical element. In this embodiment, the display technology includes a light-guide optical element (LOE). When combined with the image generation apparatus 150 and the optical system 160, it projects a high-quality image directly into the eye of the viewer. Although the image generation apparatus 150 itself is small, a very large image is viewed through it. Using the LOE technology, displays with a field-of-view of more than 30 degrees, suitable for reading a full web page, can be readily implemented with a near-to-eye LOE 3-4 mm thick. Further, the LOE technology reduces the likelihood of image ghosting. The LOE technology utilizes a parallel array of partially reflecting surfaces that are enclosed in the first body 145. The angle of incidence at which the light rays of the real image enter into the first body 145 ensures that the light rays are trapped inside the substrate guided optical element by internal reflection. After a few reflections inside the substrate, the trapped waves reach the parallel arrays of partially reflecting surfaces that couple the light rays out of the substrate into the eye of a viewer. The LOE technology provides a larger field-of-view as compared to using conventional optics.

In this embodiment, the first body 145 is made of a transparent material. The transparent material could be one of a plastic material or glass. The first body 145 could either be enclosed in a frame or be frameless. In the embodiment shown in FIG. 1, the first body 145 is a frameless body made of glass. An earpiece speaker (not shown) is located in the second body 105 in order to limit the number of electronic components in the first body 145. The first body 145 therefore has few electronic components (e.g., the major portion of the first body 145 is the transparent substrate guided optical element using the LOE technology).

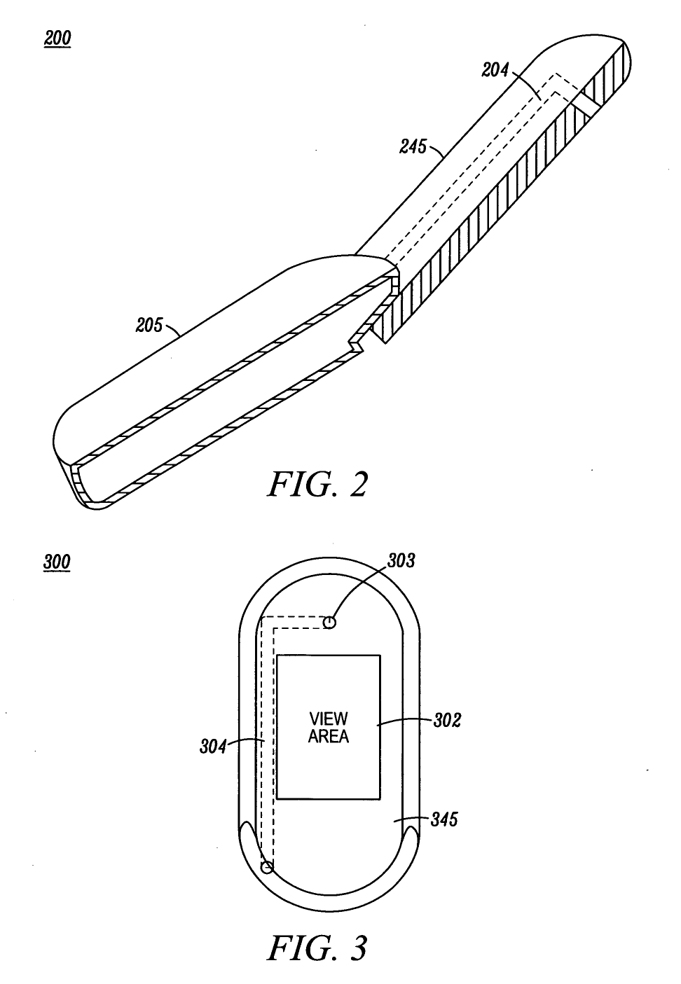

FIG. 2 and FIG. 3 depict second and third embodiments of the electronic device. In the second embodiment, the electronic device 200 is in a predetermined opened position, and in the third embodiment the electronic device 300 is in a closed position. The second body 205 includes an earpiece speaker (not shown) ported through the first body 245, 345 using a port runner 204, 304 that runs about the periphery of the first body 245, 345. The port runner could be designed to run along the periphery as shown in FIG. 3 so as to avoid any visible electronic components in the first body 245, 345 and thereby avoid any electronic components overlapping with a view area 302 in the first body 245, 345 of the electronic device 200, 300. The first body 345 includes an ear port 303. In one embodiment, simultaneous hearing and viewing can be enabled through the use of a separate loud speaker in the first body 205 of the electronic device 200.

A transparent first body 145, 245, 345 of the electronic device 100, 200, 300 imparts an interesting appearance to the clamshell type of electronic device. The transparent first body further enables a display-over-display feature wherein two displays; one display in the second body 105, 205 can be overlapped by a second display in the first body 145, 245, 345. The use of LOE technology makes it possible to have a large view area (eye motion box) as a display view area. Additionally the larger view area can be achieved without consuming more volume, as is the case with conventional optical systems. Further, the costs involved are reduced due to the use of fewer optical components. Various configurations based on the LOE or similar technology also provide the advantage that they are adaptable. Those of skill in the art will appreciate that the configurations based on the LOE technology may be embodied in other forms and manners not stated herein.

The embodiments depicted in FIG. 1 to FIG. 3 illustrate a bi-folding (or clamshell) electronic device with a virtual display that allows for an interesting design. The virtual display element can also be at least partially protected by the electronic device 400, 600, when not in use. Furthermore, these embodiments provide a compact form factor.

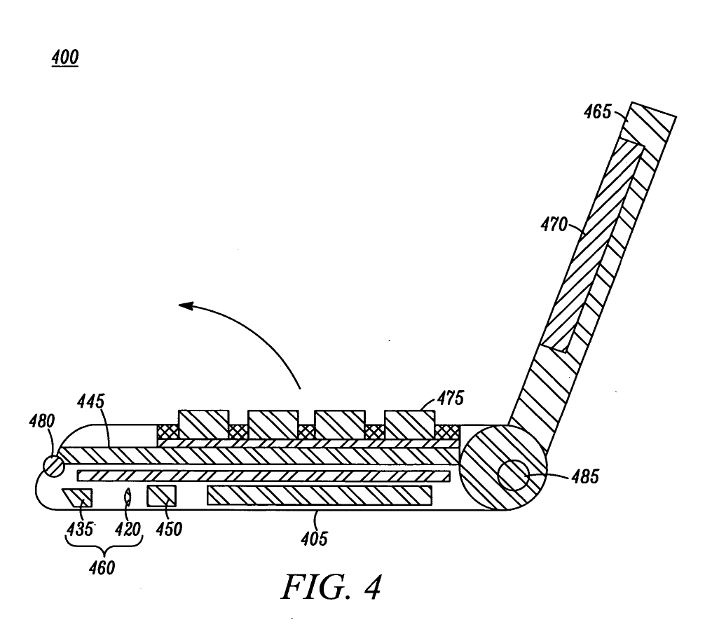

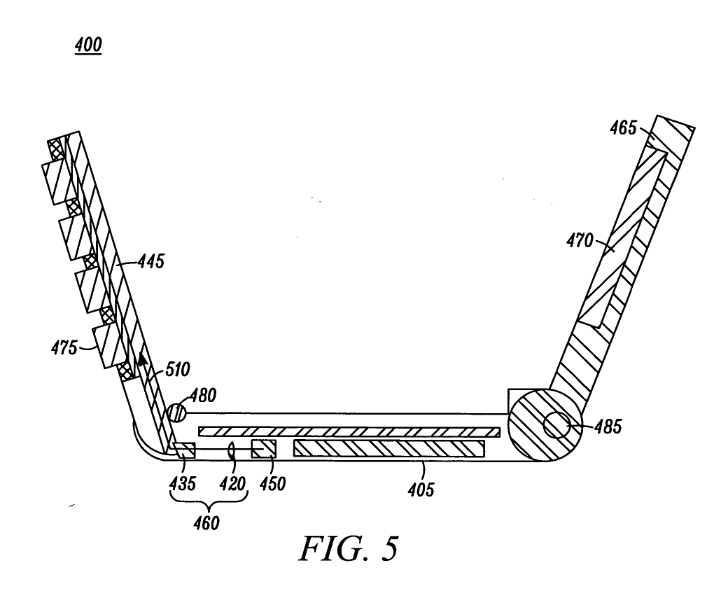

In a fourth and fifth embodiment depicted in FIG. 4 and FIG. 5, the electronic device 400 has a first body 445 enabled to provide a virtual image. A second body 405 is moveably attached to the first body 445. The first body 445 includes the substrate guided optical device. The first body 445 is capable of being moved over an angle of zero to about 160 degrees relative to the second body 405. A keypad 475 is disposed on an external surface) of the first body 445. The first body 445 is designed to stow flush to the second body 405, when the user does not need to view the virtual display.

The second body 405 houses the image generation apparatus 450 that is responsible for generating a real image in the second body 405 of the electronic device 400. Further, the second body 405 has an optical system 460 with a converging lens 420 and a collimator 435 that is responsible for guiding the light rays emanating from the real image, generated in the second body 405, into the first body 445 to generate the virtual image.

The electronic device further has a third body 465 that provides a standard display 470 connected to the second body 405 using another hinge 485. In one embodiment, the standard display is a liquid crystal display (LCD). FIG. 4 and FIG. 4 show the third body partially opened relative to the second body 405. In this embodiment, the third body 465 is disposed such that the third body 465 may be placed into a stowed position (not shown), folded over the first body 445, after the first body 445 is stowed flush to the second body 405. Those of skill in the art will appreciate that the standard display configurations may be implemented in other forms and manners not stated herein.

The first body 445 should be in a predetermined opened position relative to the second body 405 for the virtual image to be generated properly in the first body 445. The predetermined opened position is attained by moving the first body 445 relative to the second body 405 from a stowed position to a predetermined opened position. The angle by which the first body 445 can move relative to the second body 405, in order to attain the predetermined opened position or otherwise, would depend on the stowed position of the electronic device 400. FIG. 4 depicts an embodiment wherein the electronic device 400 is in the stowed position such that the first body 445 is in a top position with respect to the second body 405. The first body 445 can move through an angle of zero degrees to about 160 degrees with respect to the second body 405 around a hinge 480. In one embodiment, the predetermined opened position as depicted in FIG. 5 would be the first body 445 at a nominal angle of 110 degrees relative to the second body 405. As depicted in FIG. 5, in the predetermined opened position, the light rays 510 of the real image generated by a microdisplay of the image generation apparatus 450 are properly guided by an optical system into the first body 445 to generate the virtual image in the first body 445.

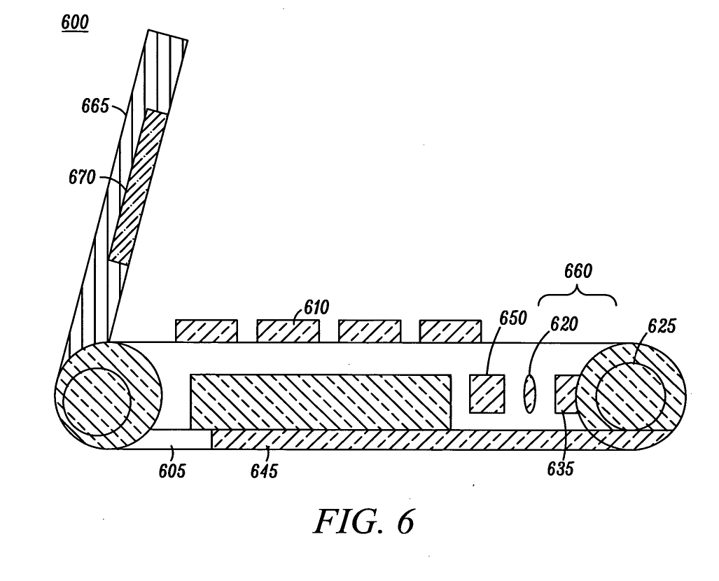

FIG. 6 depicts a fifth embodiment of an electronic device 600 in a partially stowed position such that the first body 645 is stowed in a bottom position with respect to the second body 605 while a third body 665 with a standard display 670 is partially opened relative to the second body 605. In this embodiment, the second body 605 houses a keypad 610. The first body 645 can move through an angle of zero degrees to about 260 degrees with respect to the second body 605 around a hinge 625.

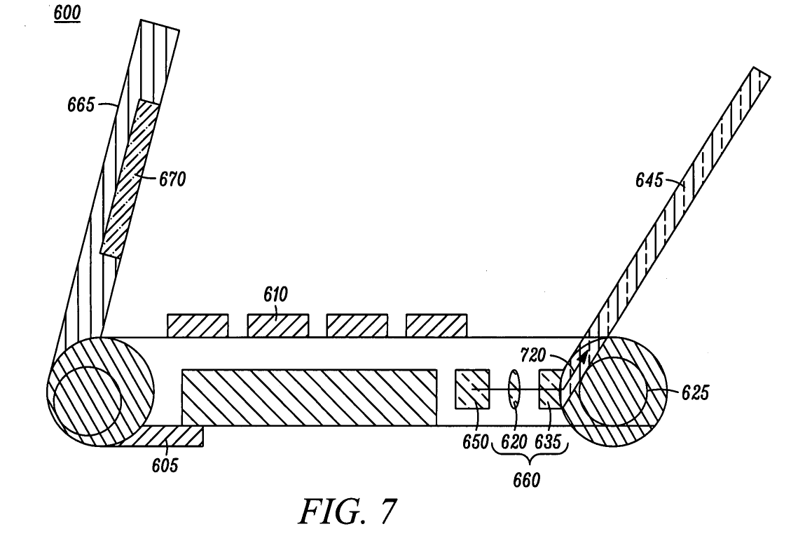

FIG. 7 shows the electronic device 600 of FIG. 6 with the first body 645 in a predetermined opened position at an angle of about 250 degrees with respect to the second body 605 as well as a third body 665 in a partially deployed position of about 100 degrees with respect to the second body 605. In the predetermined opened position, the light rays 720 of the real image generated by an imaging apparatus 650 with a microdisplay are properly guided by an optical system 660 into the first body 645 to generate the virtual image in the first body 645. The optical system 660 has a converging lens 620 and a collimator 635.

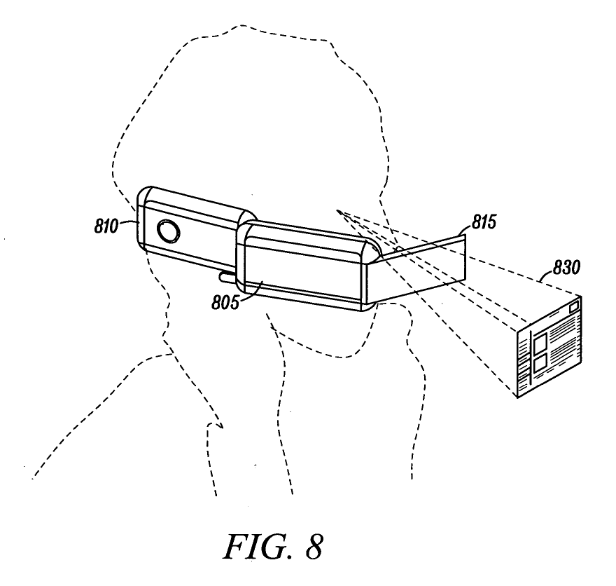

FIG. 8 depicts a user using an electronic device, such as electronic device 400, 600 to view a virtual display. The embodiments depicted in FIG. 4 to FIG. 8 illustrate a tri-folding electronic device with a virtual display that allows for an interesting design. The virtual display element can also be protected inside the electronic device 400, 600, when not in use. Furthermore, these embodiments provide a compact form factor.

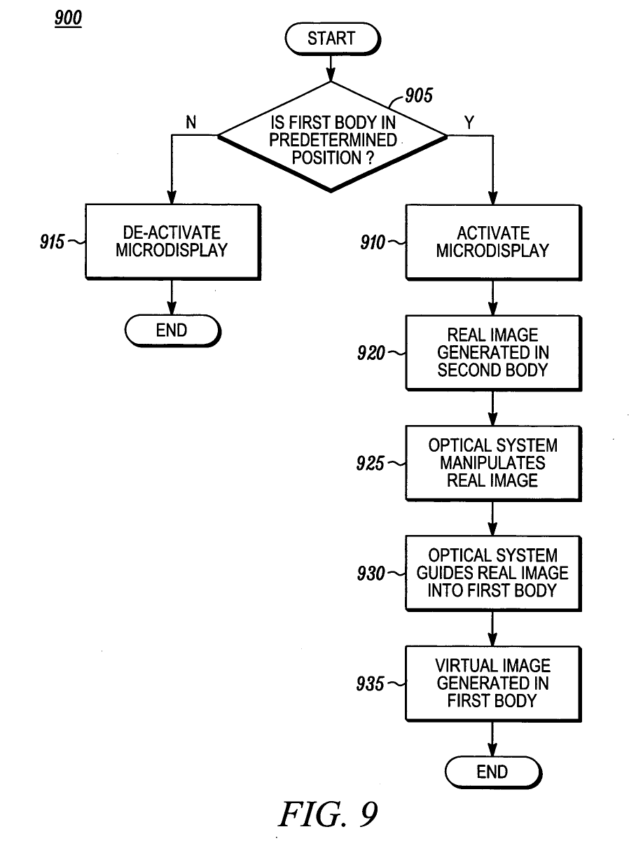

FIG. 9 is a flow diagram 900 of the steps for virtual image generation in the first body of FIGS. 1-8. The corresponding real image is generated in the second body by an image generation apparatus. In order to generate a proper virtual image, the first body should be in a predetermined opened position with respect to the second body. A switch that controls the microdisplay tracks the position of the first body with respect to the second body. As depicted in step 905 the switch is responsible for checking whether the first body is in a predetermined position with respect to the second body and then at step 910 activating the image generation apparatus when the first body is in the predetermined position with respect to the second body. Conversely, as depicted in step 915 the switch deactivates the image generation apparatus in case the first body is not in a predetermined position with respect to the second body.

When the image generation apparatus is activated, a microdisplay or LCD or the like would then generate the real image in the second body as depicted in step 920. The real image generated by the image generation apparatus is manipulated by the optical system as shown in step 925. In step 930, the light rays formed by the image generation apparatus are then directed into the first body at an appropriate angle of incidence. The light rays are made parallel before and while entering the first body. In one embodiment, before the light rays enter the first body, they would pass through a pair of collimators, one in the second body and the other in the first body. The angle of incidence into the first body is such that the light rays after entering the first body undergo internal reflection. In step 935, the virtual image is created in the first body by the internally reflected light rays, which are then directed into the eyes of the viewer by a set of partially reflecting surfaces.

This disclosure is intended to explain how to fashion and use various embodiments in accordance with the invention rather than to limit the true, intended and fair scope and spirit thereof. The foregoing discussion is not intended to be exhaustive or to limit the invention to the precise forms disclosed. Modifications or variations are possible in the light of above teachings. The embodiment(s) was chosen and described to provide the best illustration of the principles of the invention and practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

What is claimed is:

1. An electronic device comprising:
a first body, enabled to provide a virtual image;
a second body hingeably attached to the first body;
an image generation apparatus in the second body for providing a real image; and,
an optical system in the second body for assisting in transforming the real image to the virtual image.

2. The electronic device of claim 1, wherein the image generation apparatus comprises a microdisplay.

3. The electronic device of claim 1, wherein the first body is positioned parallel to the second body when the electronic device is in a stowed position.

4. The electronic device of claim 1, wherein the first body is capable of moving from zero degrees to 180 degrees relative to the second body.

5. The electronic device of claim 4, wherein the first body is enabled to provide the virtual image when the first body is in at least one predetermined position relative to the second body.

6. The electronic device of claim 5, wherein the at least one predetermined position is such that the first body is at a nominal angle of about 160 degrees relative to the second body.

7. The electronic device of claim 5 further comprising a switch for activating the image generation apparatus when the first body is in the at least one predetermined position and deactivating the image generation apparatus when the first body is not in the at least one predetermined position.

8. The electronic device of claim 1, wherein the first body further comprises a substrate guided optical element.

9. The electronic device of claim 1, wherein the optical system comprises a converging lens and at least one reflective surface.

10. The electronic device of claim 9, wherein the at least one reflective surface is a face of a prism.

11. The electronic device of claim 1, wherein the second body further comprises a first collimator.

12. The electronic device of claim 1, wherein the first body further comprises a port runner.

13. The electronic device of claim 12, wherein the second body further comprises an earpiece speaker ported through the first body using the port runner.

14. The electronic device of claim 1 further comprising:
a third body moveably attached to the second body.

15. The electronic device of claim 14, wherein the third body is enabled to provide a standard image display.

16. The electronic device of claim 1, wherein the first body is capable of moving from zero degrees to about 270 degrees relative to the second body.

17. The electronic device of claim 16, wherein the first body is enabled to provide the virtual image when the first body is in at least one predetermined position relative to the second body

18. The electronic device of claim 17, wherein the predetermined position is such that the first body is at a nominal angle of about 250 degrees relative to the second body.

19. A method for producing a virtual image in an electronic device, the method comprising steps of:
moving a first body enabled to provide the virtual image relative to a second body; and,
enabling an image generation apparatus in the second body when the first body is in a predetermined position relative to the second body.

20. The method of claim 19, further comprising:
disabling the image generation apparatus when the first body is not in the predetermined position relative to the second body.

21. The method of claim 19, further comprising:
displaying the virtual image, when the image generation apparatus is enabled.

22. An electronic device comprising:
a first element housing an image generation apparatus for providing a real image;
a hinge coupled to the first element; and
a second element, coupled to the hinge, for providing a virtual image based on the real image.
